(19) United States
(12) Patent Application Publication
(10) Pub. No.: US 2026/0261486 A1
(43) Pub. Date: Sep. 3, 2026

(54) AUTOMATED TRAINING OF SERVICE QUALITY MODELS

(71) Applicant: Telefonaktiebolaget LM Ericsson (PUBL), Stockholm (SE)

(72) Inventors: Gergely DÉVAI, Budapest (HU); Attila BÁDER, Paty (HU)

(73) Assignee: Telefonaktiebolaget LM Ericsson (PUBL), Stockholm (SE)

(21) Appl. No.: 18/881,736

(22) PCT Filed: Aug. 15, 2022
(86) PCT No.: PCT/IB2022/057623

§ 371 Date: Jan. 7, 2025

(51) Int. Cl. H04L 41/149; H04L 41/16; H04L 41/5067

(52) U.S. Cl. CPC H04L 41/149; H04L 41/16; H04L 41/5067

(57) ABSTRACT

Embodiments include methods for training artificial intelligence/machine learning (AI/ML) models to predict end-user quality-of-experience (QoE) in a communication network. Such methods include performing the following for each of a plurality of test sessions for a service: transmitting a test record via the communication network to obtain a received test record (where the transmitted test record and the received test record include media associated with the service); obtaining network quality-of-service (QoS) metrics representative of communication network performance during the test session; and obtaining end-user QoE metrics for the service during the test session based on the transmitted test record, the received test record, and one or more bootstrapper models associated with the service. Such methods include, based on the network QoS and end-user QoE metrics obtained for the plurality of test sessions, training one or more AI/ML models to predict end-user QoE for the service based on network QoS metrics.

### TECHNICAL FIELD

The present disclosure relates generally to communication networks and more specifically to techniques for automating the training of artificial intelligence/machine learning (AI/ML) models used for detecting and/or predicting end-user quality of experience (QoE) in communication networks (e.g., mobile or cellular networks).

### BACKGROUND

Voice services were the first types of services offered in early mobile networks. Thus, optimizing mobile networks for good voice quality has long been a priority for mobile operators. This was especially important for Voice over Long-Term Evolution (VoLTE) in 4G LTE networks, where the voice is transported by packet-switched technologies rather than circuit-switched technologies used in earlier 2G and 3G networks.

The volume of mobile broadband (MBB) traffic (e.g., streaming video, conversational video, web services, file download, etc.) carried by mobile networks is continuously growing, so providing good service quality for MBB traffic is increasingly important. LTE networks were often optimized to provide good quality-of-service (QoS) and user experience of MBB traffic.

The fifth generation (“5G”) of cellular systems, also referred to as New Radio (NR), was initially standardized 3GPP Rel-15 and continues to evolve in subsequent releases. NR is developed for maximum flexibility to support a variety of different use cases including enhanced mobile broadband (eMBB), machine type communications (MTC), ultra-reliable low latency communications (URLLC), side-link device-to-device (D2D), and several other use cases. 5G/NR technology shares many similarities with fourth-generation LTE.

At a high level, the 5G System (5GS) consists of a radio access network (RAN) and a Core Network (CN). The RAN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

The ever increasing complexity of communication networks, including 5G networks, drives the evolution of analytics systems that support operation, optimization, and planning of these networks. This includes detecting and addressing sudden, undesired changes in network operation and/or performance (e.g., failures). These analytics systems, in turn, require collecting and processing of enormous amounts of data.

Advanced analytics systems, such as Ericsson Expert Analytics (EEA), are based on collecting and correlating elementary network events from different network domains, such as core, radio, and transport networks. Such analytics systems calculate user- and session-level E2E service quality metrics (S-KPIs) as well as radio and network resource metrics (R-KPIs) that characterize the radio environment or network operation at user and session level. These types of solutions are suitable for session-based troubleshooting and analysis of network issues.

Event-based analytics require real-time collection and correlation of node and protocol events from different RAN and CN nodes, probing signaling interfaces, and sampling of user-plane traffic. Additionally, event-based analytics require an advanced database, a rule engine, and a “big data” analytics platform.

It is expected that 5G networks will serve a higher number of UEs and support a wider variety of service types than 4G and previous-generation networks. This will significantly increase the incoming event rate and type to be processed by analytics systems to support network QoS and end-user quality-of-experience (QoE).

Conventional techniques are based on a semi-static quality-of-service (QoS) framework that includes different predefined combinations of QoS characteristics such as packet delay, packet error rate, priority level, etc. In 5G, each of these combinations is identified by an index called 5G QoS Identifier (5QI). When a user initiates a specific service, the 5GC assigns that service to a QoS flow (between UE and 5GC, via RAN) with QoS characteristics (and associated 5QI) corresponding to the service's QoS requirements.

QoS policy enforcement is performed in the RAN, but without any information about end-user QoE or about classification of the specific services or applications of the end users. Such information is currently not available to the RAN. Since network QoS (e.g., 5QI) cannot be translated to end-user QoE without service classification information, enforcing QoS policies does not guarantee end-user QoE for specific services, specific network slices, or specific cells over various traffic loads, mixtures of traffic types, and/or radio conditions.

Many third-party service providers deliver media services (e.g., streaming video) to service end users “over the top” (OTT) of mobile networks; these services are often referred to as “OTT services”. Large OTT service providers (e.g., Netflix) often have service level agreements (SLAs) with the network operators that specify required end-user QoE for OTT services delivered over the mobile networks. As part of these SLAs, network operations must monitor end-user QoE for these services and optimize the network as necessary to meet SLA requirements.

Conventional analytics systems deployed passive “probes” in the networks to collect packet-level information needed to calculate meaningful QoS and QoE metrics for various types of network traffic. One factor that severely restricts this type of monitoring is encryption of packet protocol headers and payload (or content). End-to-end encryption is used for most user traffic carried by a 5G network, such that the mobile network cannot identify traffic type directly from the user traffic itself. It is expected that end-to-end encryption will also be used for domain name service (DNS) traffic, which further hinders traffic identification in the mobile network.

### SUMMARY

One way to combat this problem is to leverage the power of artificial intelligence and machine learning (AI/ML) to extract relevant patterns from raw traffic features and publicly accessible packet headers. For example, AI/ML models can be applied to determine complex relationships between network QoS (e.g., KPIs) and end-user QoE. Even so, AI/ML models require a significant amount of labelled training data, particularly slowly converging AI/ML models that are generally accepted as providing the highest accuracy. Conventional techniques for collection and labelling of training data require significant amounts of human resources, making them very slow and costly. Techniques that automate training of AI/ML models used for end-user QoE prediction in a mobile network are needed.

Embodiments of the present disclosure address these and other problems, issues, and/or difficulties, thereby facilitating the otherwise-advantageous use of AI/ML models for end-user QoE prediction in a mobile networks.

Some embodiments include methods (e.g., procedures) for training AI/ML models to predict end-user QoE in a communication network (e.g., 5G network).

These exemplary methods can include, for each of a plurality of test sessions for a service, transmitting a test record via the communication network to obtain a received test record. The transmitted test record and the received test record include media associated with the service. These exemplary methods can also include, for each test session, obtaining network QoS metrics representative of communication network performance during the test session and obtaining end-user QoE metrics for the service during the test session based on the transmitted test record, the received test record, and one or more bootstrapper models associated with the service. These exemplary methods can also include, based on the network QoS metrics and the end-user QoE metrics obtained for the plurality of test sessions, training one or more AI/ML models to predict end-user QoE for the service based on network QoS metrics.

In some embodiments, these exemplary methods can also include, for each test session, creating training data by associating the end-user QoE metrics as labels for the network QoS metrics at corresponding times during the test session. In such embodiments, training the one or more AI/ML models is based on the training data created for the plurality of test sessions.

In some embodiments, obtaining end-user QoE metrics for the service during the test session includes applying the one or more bootstrapper models to the received test record to obtain one or more test session performance metrics, and determining one or more end-user QoE metrics based on a function of the test session performance metrics and reference performance for the transmitted test record. In some of these embodiments, obtaining end-user QoE metrics for the service during the test session also includes applying the one or more bootstrapper models to the transmitted test record to obtain one or more reference performance metrics, which represent the reference performance for the transmitted test record. In other of these embodiments, the reference performance is based on known or predetermined performance of the one or more bootstrapper models with respect to the transmitted test record Various examples of services, bootstrapper models associated with services, and performance metrics for bootstrapper models are disclosed herein.

Other embodiments include network analytics systems configured to perform operations corresponding to any of the exemplary methods described herein. Other embodiments include non-transitory, computer-readable media storing program instructions that, when executed by processing circuitry, configure such network analytics systems to perform operations corresponding to any of the exemplary methods described herein.

These and other embodiments described herein can utilize bootstrapper models that are readily available for many services such as speech-to-text models for various languages, object detection models for video streams, picture-to-text models, etc. Embodiments can reduce cost and complexity of generating training data as compared to conventional techniques, and can improve accuracy and/or precision of the QoE AI/ML models resulting from the training data.

Embodiments are applicable to a wide range of services and/or use cases that are expected in 5G networks, including services that encrypt traffic sent over the 5G network. By improving the training of AI/ML models used to predict end-user QoE based on network QoS, embodiments facilitate better prediction of end-user QoE in networks, thereby improving network compliance with QoE requirements in OTT service provider SLAs.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary 5G/NR network architecture.

FIG. 2 shows an exemplary non-roaming architecture of a 5G network with service-based interfaces and various 3GPP-defined NFs.

FIG. 3 shows an exemplary multi-domain network comprising a RAN, a packet-based core network (CN), and an IP Multimedia Subsystem (IMS).

FIG. 4 shows an exemplary mobile network according to various embodiments of the present disclosure.

FIG. 5 shows an exemplary system for development or production of service specific QoE models, according to various embodiments of the present disclosure.

FIG. 6 shows an exemplary method (e.g., procedure) for training AI/ML models to predict end-user QoE in a communication network, according to various embodiments of the present disclosure.

FIG. 7 shows a communication system according to various embodiments of the present disclosure.

FIG. 8 shows a UE according to various embodiments of the present disclosure.

FIG. 9 shows a network node according to various embodiments of the present disclosure.

FIG. 10 shows host computing system according to various embodiments of the present disclosure.

FIG. 11 is a block diagram of a virtualization environment in which functions implemented by some embodiments of the present disclosure may be virtualized.

FIG. 12 illustrates communication between a host computing system, a network node, and a UE via multiple connections, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

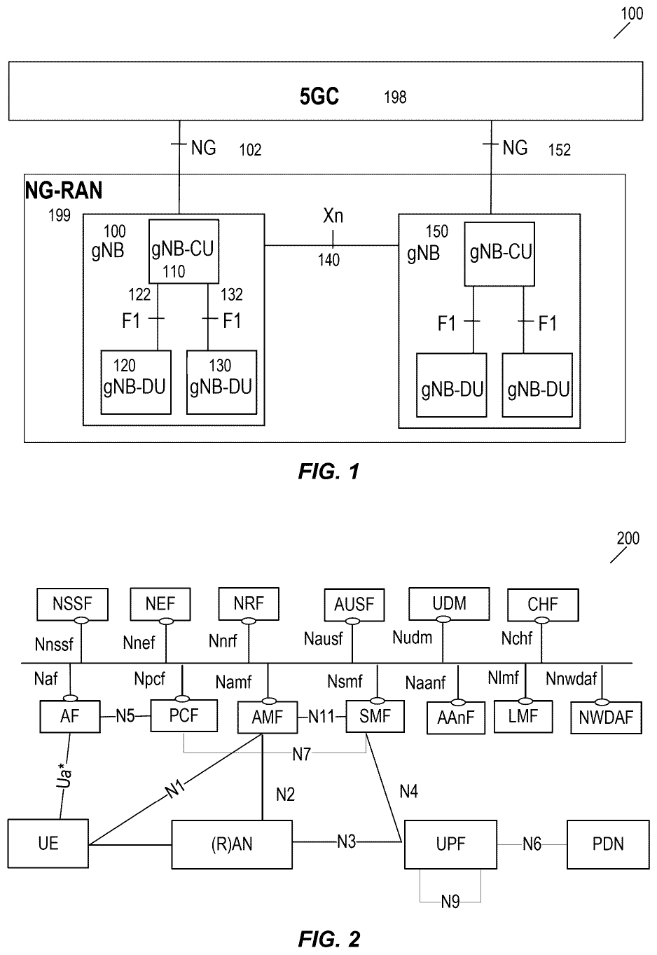

FIG. 1 shows a high-level view of an exemplary 5G network 100, including a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Central Unit (CU or gNB-CU) and one or more Distributed Units (DU or gNB-DU). For example, gNB 100 includes gNB-CU 120 and gNB-DUs 120 and 130. CUs (e.g., gNB-CU 120) are logical nodes that host higher-layer protocols and perform various gNB functions such controlling the operation of DUs. A DU (e.g., gNB-DUs 120, 230) is a decentralized logical node that hosts lower layer protocols and can include, depending on the functional split option, various subsets of the gNB functions. A gNB-CU connects to one or more gNB-DUs over respective F1 logical interfaces (e.g., 122 and 132).

One change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

FIG. 2 shows an exemplary non-roaming architecture of a 5G network (200) with service-based interfaces and various 3GPP-defined NFs. These include the following NFs, with additional details provided for those most relevant to the present disclosure:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF) supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point, with SMFs via the N11 reference point, and with RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs. In general, NEF provides services similar to services provided by SCEF in EPC.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—interacts with other NFs to collect relevant data and provides network analytics information (e.g., statistical information of past events and/or predictive information) to other NFs.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF. The terms “UDM” and “UDM function” are used interchangeably herein.

IP Multimedia Subsystem (IMS) is an architectural framework for delivering multimedia services to wireless devices based on these Internet-centric protocols. IMS was originally specified by 3rd Generation Partnership Project (3GPP) in Release 5 (Rel-5) as a technology for evolving mobile networks beyond GSM, e.g., for delivering Internet services over GPRS. IMS has evolved in subsequent releases to support other access networks and a wide range of services and applications.

At a high-level, the functionality of the IMS network can be sub-divided into two types: control and media, and application enablers. The control functionality comprises Call Session Control Function (CSCF) and Home Subscriber Server (HSS). The CSCF is used for session control for devices and applications that are using the IMS network. Session control includes the secure routing of the session initiation protocol (SIP) messages, subsequent monitoring of SIP sessions, and communicating with a policy architecture to support media authorization. CSCF functionality can also be divided into Proxy CSCF (P-CSCF), Serving CSCF (S-CSCF), and Interrogating CSCF (I-CSCF).

CSCF also interacts with the HSS, which is the master database containing user and subscriber information to support the network entities handling calls and sessions. For example, HSS provides functions such as identification handling, access authorization, authentication, mobility management (e.g., which session control entity is serving the user), session establishment support, service provisioning support, and service authorization support.

A Media Resource Function (MRF) can provide media services in a user's home network and can manage and process media streams such as voice, video, speech-to-text, and real-time transcoding of multimedia data. In general, a WebRTC Gateway allows native- and browser-based devices to access services in the network securely.

As briefly mentioned above, the ever increasing complexity of communication networks, including 5G networks, drives the evolution of analytics systems that support operation, optimization, and planning of these networks. This includes detecting and addressing sudden, undesired changes in network operation and/or performance (e.g., failures). Advanced analytics systems require collecting and correlating elementary network events from different network domains, such as CN, RAN, and transport networks. Such analytics systems calculate user- and session-level E2E service quality metrics (S-KPIs) as well as radio and network resource metrics (R-KPIs) that characterize the radio environment or network operation at user and session level.

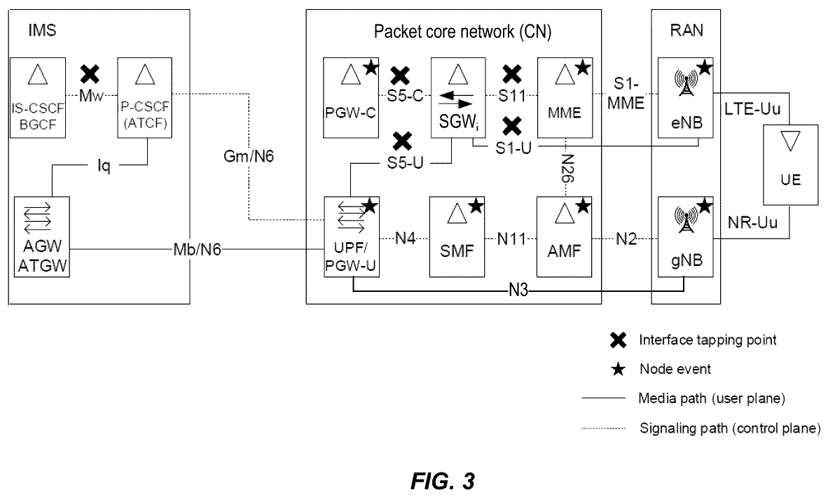

FIG. 3 shows an exemplary multi-domain network comprising a RAN, a packet-based CN, and an IMS. As shown in FIG. 3, the RAN includes eNBs that provide the LTE-Uu radio interface and gNBs that provide the NR-Uu interface to UEs. The CN includes SMF, AMF, and UPF in 5GC discussed above, as well as mobility management entity (MME), serving gateway (SGW), and packet gateway (PGW) that are part of the Evolved Packet Core (EPC) associated with LTE networks. The UPF connects to the IMS via the N6 interface, such that IMS in FIG. 3 is an instance of the PDN shown in FIG. 2.

FIG. 3 also shows various “tapping points” where data can be collected from the three domains of the network. For example, node events (e.g., PM counters) can be collected from eNBs, gNBs, AMF, SMF, UPF, MME, and PGW. Likewise, interface events can be collected from S5-U (user), S5-C (control), S1-U, and S5-U interfaces in CN as well as from Mw interface between P-CSCF and IS-CSCSF in IMS. In addition to detecting events and/or conditions at the individual nodes and/or interfaces, some more advanced analytics systems combine information collected from the multiple domains to determine “user experience” analytics that represent performance experienced by an end user for a specific service.

Detecting and addressing sudden, undesired changes in network operation and/or performance (e.g., failures) is not the only reason for network monitoring by analytics systems. As briefly mentioned above, large OTT service providers (e.g., Netflix) often have SLAs with the network operators that specify required end-user QoE for OTT services delivered over the mobile networks. As part of these SLAs, network operations must monitor end-user QoE for these services and optimize the network as necessary to meet SLA requirements.

Conventional analytics systems deployed passive “probes” in the networks to collect packet-level information needed to calculate meaningful QoS and QoE metrics for various types of network traffic. One factor that severely restricts this type of monitoring is encryption of packet protocol headers and payload (or content). For example, the latest version of transport layer security (TLS) for TCP-based transmission and the DTLS variant for UDP-based transmission provide enhanced security using forward secrecy and encrypted handshakes.

As another example, QUIC protocol is intended to improve performance of connection-oriented web applications that are currently using TCP for transport. QUIC includes two main features that reduce latency as compared to TCP, based on an understanding of behavior of upper-layer HTTP traffic. First, QUIC establishes multiple multiplexed connections between two endpoints using UDP. Second, since most HTTP connections will demand TLS, QUIC makes the exchange of setup keys and supported encryption protocols part of the initial handshake process. Thus, QUIC inherently encrypts all the data at the transport layer, which significantly limits the observability of protocol messages for network performance monitoring and troubleshooting.

As another example, Domain Name Service (DNS) is a fundamental Internet building block that is used when a user visits a website, sends an email, has an IM conversation, or does almost anything else online. When a user opens an application, a DNS client retrieves server IP address(es) for the application domain from a DNS resolver. Currently most DNS traffic today is sent unencrypted over UDP/TCP, but there are different IETF drafts proposing DNS encryption to prevent reading of DNS traffic in the middle between endpoints. Various proposals include DNS over HTTP/2 (DOH), DNS over TLS, DNSCrypt, etc. With these proposals, only the DNS resolver has visibility into the DNS messages associated with user traffic.

As briefly mentioned above, network QoS policy is enforced in the NG-RAN but without any information about end-user QoE or about classification of the specific services or applications of the end users. Since network QoS (e.g., 5QI) cannot be translated to end-user QoE without service classification information, enforcing QoS policies does not guarantee end-user QoE for specific services, specific network slices, or specific cells over various traffic loads, mixtures of traffic types, and/or radio conditions. Furthermore, information about which services are associated with user data traffic is difficult to obtain due to packet encryption and other reasons outlined above. End-user QoE information may be available at the UE, but that information is also unavailable to the network.

One way to combat these problems is to use artificial intelligence and machine learning (AI/ML) to extract relevant patterns from raw traffic features and publicly accessible packet headers. For example, AI/ML models can be applied to determine complex relationships between network QoS (e.g., KPIs) and end-user QoE. Even so, AI/ML models require a significant amount of labelled training data, particularly slowly converging AI/ML models that are generally accepted as providing the highest accuracy.

In these applications, each labelled training data record includes one or more observed network QoS KPIs (e.g., radio signal strength, packet loss, etc.) and a corresponding “label” that describes a perceived end-user QoE for a particular service that was delivered over the network that provided those QoS KPIs. Example labels can be qualitative (e.g., good or bad), quantitative (e.g., 1-5 scale), or a combination thereof.

Conventional techniques for collection and labelling of training data require significant amounts of human resources, making them very slow and costly. Humans need to view or listen to live or pre-recorded service sessions (e.g., voice calls, streaming videos, video chats, screen sharing, etc.) and rate QoE of the overall session or for individual portions of the session (e.g., one label per minute). In addition to being slow and costly, this process may not produce accurate enough results. For example, a human may assign a qualitative QoE (e.g., good or bad) but cannot or does not assign any more detailed grades to the session (or portion thereof).

Although automatic labelling of training data according to an existing QoE model is theoretically possible, in practice it is useless. In other words, if there is an existing model that assigns QoE to QoS KPI values, then that model must have already been trained (at least to some degree) and should instead be used directly. However, good quality hand-crafted models are difficult to obtain due to the complexity of QoE prediction based on network QoS KPIs.

Embodiments of the present disclosure address these and other problems, issues, and/or difficulties by novel, flexible, and efficient techniques that automate training of AI/ML models used for end-user QoE prediction in a mobile network, thereby facilitating the otherwise advantageous deployment of such models for this purpose.

Embodiments are based on the available of a service-specific AI/ML model (“bootstrapper model”) whose input is a session of the service and whose output solves a problem or addresses a need. Example bootstrapper models include a speech-to-text model for transcribing voice calls, an object detection model for video streaming, an optical character recognition (OCR) model for images or video, etc.

The bootstrapper model is used to automatically generate QoE labels for training data consistent of network QoS KPIs. This can be done by running test sessions of the service in the network, during which the network QoS KPIs parameters are regularly recorded. The bootstrapper model is applied both to the original service input (i.e., on the sender side) and to the service output (i.e., on the receiver side) after passing through the network that delivers the recorded QoS KPIs. These two outputs of the bootstrapper model are compared and service-specific QoE metrics (i.e., labels) are assigned based on the comparison.

Consider an example where the bootstrapper model is a speech-to-text model that transcribes text from input speech (e.g., using an AI/ML model). A pre-recorded voice message is transmitted in a test voice call. The bootstrapper model transcribes the input voice message with a 90% accuracy but transcribes the output voice message (i.e., at the receiver) with only 77% accuracy due to dropped packets, etc. A “medium” QoE label is automatically assigned to the session based on this difference and some predetermined criteria. Network QoS KPIs indicative of these conditions during the session are collected and associated with the QoE label.

Subsequently, the labelled data records generated in this manner can be used to train a service-specific AI/ML model that predicts service-specific (e.g., voice) end-user QoE from network QoS KPIs. This service-specific AI/ML model can then be used to adjust network configurations to maintain or improve QoE, and/or to determine effects of network QoS changes on end-user QoE for that service.

Embodiments can provide various benefits and/or advantages. For example, rather than requiring custom AI/ML models, embodiments can utilize bootstrapper models that are readily available for many services such as speech-to-text models for various languages, object detection models for video streams, picture-to-text (OCR) models, etc. Moreover, embodiments can utilize well-established procedures to generate test data, such drive tests in live networks and lab tests that introduce artificial disturbances that affect network QoS in a controlled manner.

Furthermore, by automating the QoE labelling process, embodiments reduce the cost and complexity of generating training data as compared to conventional human-centered techniques. Automating the generation of training data also improves accuracy and/or precision of the QoE AI/ML models resulting from the training data, since it enables more training data to be generated and applied to train these AI/ML models.

Additionally, embodiments are applicable to a wide range of services and/or use cases that are expected in 5G networks, including services that use QUIC, TLS, DTLS, or other protocols to encrypt traffic sent over the 5G network. Embodiments avoid conventional problems with encrypted traffic by using the service-specific bootstrapper model for classifying QoE before encryption at the sender and after decryption at the receiver.

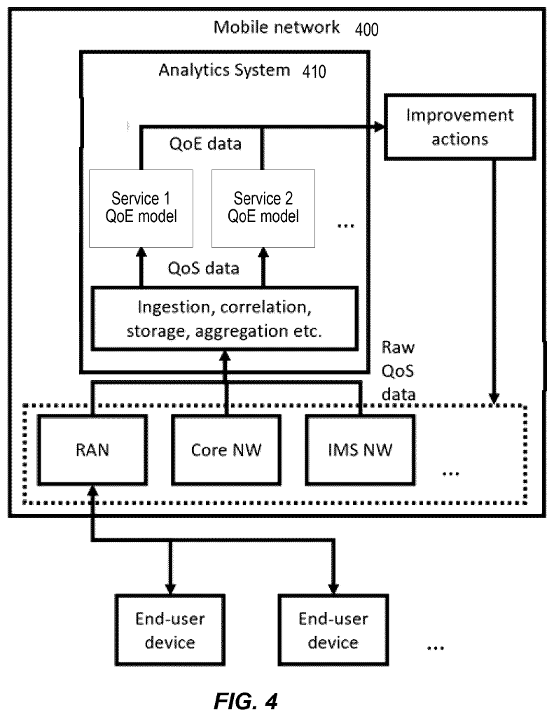

FIG. 4 shows a high-level view of an exemplary mobile network according to embodiments of the present disclosure. In this mobile network (400), end-user devices (e.g., UEs) are connected to the RAN (e.g., NG-RAN) via standardized protocols, and communicate with the CN (e.g., 5GC) and IMS via the RAN. The mobile network includes an analytics system (410) that collects raw time series data (e.g., PM events and counters, alarms etc.) from the RAN, CN, and IMS. The collected data itself may include network QoS metrics (or KPIs) or the analytics system may process the collected data to obtain network QoS metrics. These actions are collectively represented by the ingestion, correlation, storage, and aggregation block.

The network QoS metrics determined for any particular time are relevant for all users and services that use the network at that particular time (i.e., all users and services that are using the network resources to which the network QoS metrics apply). These network QoS metrics are used as inputs to service-specific QoE models that predict end-user QoE for specific services. Two QoE models for two exemplary services (i.e., Service1 and Service 2) are shown in FIG. 4.

Service-specific QoE predictions are input to a network resource management function that determines improvement actions (as needed) in one or more network domains (e.g., RAN, CN, IMS) to fix errors, increase efficiency, etc. For example, improvement actions may include traffic steering, policy enforcement, etc. After the determined improvement actions are implemented in the mobile network, the analytics system can collect further QoS data and apply the service-specific QoE models to observe the effects of the actions.

Embodiments of the present disclosure are particularly concerned with the development of service-specific QoE models such as shown in FIG. 4. In particular, embodiments are concerned with training of AI/ML models that generate service-specific end-user QoE based on network QoS metrics or KPIs.

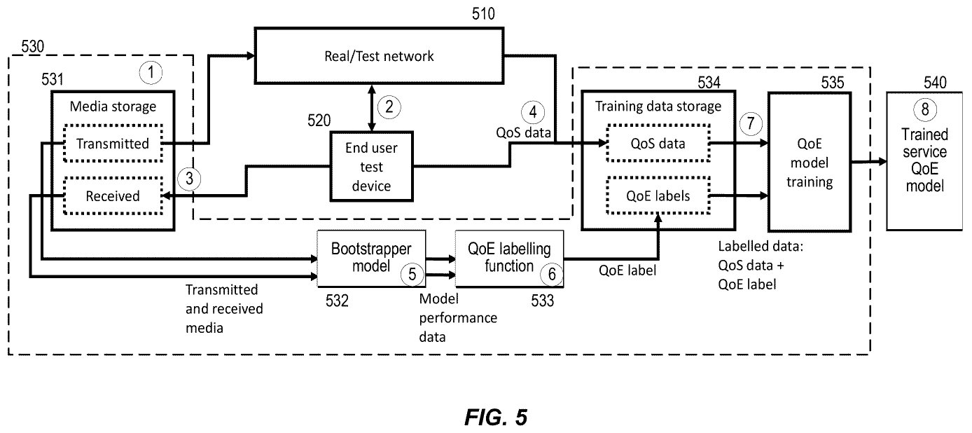

FIG. 5 shows an exemplary system for development or production of service-specific QoE models, according to various embodiments of the present disclosure. The system shown in FIG. 5 includes a communication network (510), which can be a live network or a test/development network (e.g., in a lab). For example, the network can be a 5G network such as shown in other figures. The system shown in FIG. 5 also includes an end-user test device (520, e.g., UE), although multiple end-user devices can be used for collection of data in the manner described below.

The system shown in FIG. 5 also includes a service-specific QoE model training function (530), which includes various sub-functions or blocks such as media storage (531), bootstrapper model (532), QoE labelling (533), training data storage (534), and QoE model training (535). The output of the service-specific QoE model training function is one or more trained AI/ML models (540) that predict service-specific end-user QoE from network QoS metrics.

FIG. 5 also includes various numerical labels that illustrate operation of the system. These labels are intended to facilitate explanation rather than to require or imply any particular order of operations, unless expressly stated otherwise.

In operation 1, service-specific media are stored in the media storage. For example, the service-specific media can include individual files with conversational voice, video, images, etc., essentially any type of media file that is representative of a service of interest. In operation 2, one or more test sessions are initiated between the test device and the network. In each session, one service-specific media file is transmitted by the network to the test device, or vice versa.

Typically a large amount of labelled data is needed for service-specific QoE model training, so many test sessions need to be run in operation 2 for each service of interest. For example, each test session can correspond to specific network traffic conditions (e.g., congestion, resource availability), radio conditions (e.g., signal strength), mobility events (e.g., handover), etc. Furthermore, different media files of the same service (e.g., different voices) may be used in the different sessions. Although more results are always preferred, Applicants have recognized that 10-20 sessions evenly distributed among a range of possible conditions will provide adequate results for model training. In other words, coverage of different conditions is more important than than the absolute number of sessions of a specific service.

In operation 3, the service-specific media file transmitted in operation 2 is received (e.g., by test device or by network) and stored in the media storage. Note that the received file may differ from the original file due to network conditions in the live or test network. For example, the transmitted content may experience delays, distortion, resolution changes, muted or frozen portions, etc.

In operation 4, QoS data or metrics are collected for each test session. The collection may be done during the test session or after the test session based on raw data stored during the test session. The QoS metrics may be collected from the network (e.g., network QoS metrics) and/or from the test device (e.g., UE QoS metrics). In any event, the collected QoS metrics are representative of the network traffic conditions (e.g., congestion, resource availability), radio conditions (e.g., signal strength), mobility events (e.g., handover), etc. that existed during the test session. The collected QoS data is stored in the training data storage.

In operation 5, for each training session, the bootstrapper model is run on both the original transmitted service-specific media file and the received service-specific media file, and model performance on both files is evaluated. In operation 6, for each training session, the QoE labelling function calculates, derives, and/or determines a QoE label based on the two model performance figures determined in operation 5. The QoE labels are stored in association with the QoS data for the corresponding test session in the training data storage. These two pieces of data together form labelled data. Different examples of bootstrapper models were summarized above and are described in more detail below, along with exemplary performance evaluation and QoE labelling techniques.

The main goal of operation 6 is to derive an objective QoE score based on AI/ML model performance measures for a single test session, as described above. In other embodiments, if the bootstrapper model is a simple classification model and many test sessions can be carried out under the same network conditions (e.g., in lab), then classical statistical metrics such as accuracy (AC), precision (PC), recall (RC), F1-score, or area under curve (AUC) can be used so long as suitable performance metrics are available for the bootstrapper model. Note that F1 is defined as follows:

$$PC = True Positive / ( True Positive + False Positive ) , \\ RC = True Positive / ( True Positive + False Negative ) , and \\ F 1 Score = ( 2 * Precision * Recall ) / ( Precision + Recall ) .$$

In contrast, AUC can be used to characterize performance of binary classification, e.g., good or bad.

Different QoE labelling techniques may be used in various embodiments. For example, QoE may be expressed as a numerical score within a range of minimum (worst) to maximum (best), such as an integer in the range of 1-5 or 1-10. In other embodiments, QoE can be expressed as QoE=F(P(t), P(r)), where P(t) is the bootstrapper model performance on the original transmitted file and P(r) is the bootstrapper model performance on the corresponding received file, and F is some linear or non-linear function. As a specific example:

$$QoE = 4 * ( Pt ) / ( Po ) + 1 , if Pt \leq Po , \\ 5 , otherwise .$$

The above example is based on the original content being a perfect reference with any degradation due to transmission via the network. As such, the inaccuracy of the bootstrapper model (e.g., only 80% pattern recognition) is eliminated.

Besides the generic F1-score, service-specific metrics can also be used. In case of voice-to-text models, one common metric is word error rate (WER) defined as:

$$WER = 100 ( I + D + S ) / N ,$$

where I=incorrect word insertions, D=incorrect word deletions, S=incorrect word substitutions, and N=number of words transcribed, WER or character error rate (CER) can be used for OCR models. CER is defined in a similar manner as WER but based on individual characters (e.g., letters and numbers) rather than entire words.

Embodiments of the present disclosure are based on availability of bootstrapper model performance metrics for the test content. Some embodiments can utilize a “reference” from which model performance is determined, e.g., original text of a voice call in the case of a voice-to-text model, object types and positions versus time in the case of a model for object detection in video. If a relatively small of amount of test content is used (e.g., 10-20 sessions as above), this is usually not a problem since the “reference” need to be created only once.

Other embodiments can utilize do not depend on availability of a reference for evaluating bootstrapper model performance. In these embodiments, the bootstrapper model first runs on the original content and its output is considered to be the reference. The bootstrapper model is then run on the received content and its output is compared with the reference to determine model performance from which QoE metrics can be calculated in any of the ways described above. These embodiments may be preferrable to used when a large amount of test content is needed to train the service-specific AI/ML models, and/or when obtaining a “true” reference is infeasible and/or impractical.

In general, these embodiments require that the bootstrapper model performs relatively well (e.g., according to some service-specific criteria) on the original test content. If the bootstrapper model is evaluated as performing well on a relatively small amount of representative test content, then it is likely to perform well on the remainder of the test content for the service, albeit with some expected variation on individual test content. As an alternative, test content on which the bootstrapper model is known to perform well can be selected for use in the test sessions.

In some embodiments, the QoE labelling function in FIG. 5 can assign one QoE label per test session. In other embodiments, the QoE labelling function can assign one QoE label per segment of the test session (e.g., one QoE label for each 15-second interval) so long as the bootstrapper model output is available per segment. For best results, the QoS metrics should also be collected or determine with the same time granularity as the QoE labelling (e.g., every 15 seconds). In some cases, the reporting period of the QoS metrics can be used as the segment length for QoE labelling. In any event, the underlying principle is correspondence of QoS and QoE data to facilitate AI/ML model training.

Additionally, per-segment labelling provides more training samples for the QoE model and can capture quality changes during a session. For example, the first part of a session can have good quality (good QoS metrics, good QoE labels) then a handover occurs to a congested cell and quality drops for the second part of the session. Instead of providing an “medium” QoE label to the entire session, segments of the first part receive “good” QoE labels and segments of the second part receive “bad” QoE labels, which are stored in association with QoS metrics indicative of the changing network conditions.

In operation 7, the labelled data is obtained from the training data storage and used to train a service specific QoE model, such as by a supervised learning algorithm. This process outputs a trained service specific QoE model that predicts end-user QoE for a specific service (e.g., voice, video, etc.) based on network QoS metrics indicative of network conditions in which the service was used/delivered. In operation 8, the trained model can then be deployed in the analytics system shown in FIG. 4. Some use case examples are described below.

For voice service (e.g., circuit-switched or packet-switched), a voice-to-text translator or transcriber can be used as the bootstrapper model. The model should mark start and end of phrases and predict their modality using the tones. Certain points in the output text should also be labelled by corresponding timestamps (e.g., each second of the voice session). An example performance metric for this bootstrapper model output is weighted average of the following:
edit distance between actual text and corresponding model output, and
cumulative differences between time stamps of actual text and corresponding model output.
   The received voice files may exhibit the following degradations that are reflected in QoE labels:
delays, such that the original and received voice messages have different time stamps for corresponding portions;
missing chunks of the received voice message, giving incomplete output text; and
garbled voice, giving incorrect text transcribed from the received voice message.

For streaming and conversational video services, an object detector can be used as the bootstrapper model. This model should be able to classify certain objects appearing in the incoming video stream, such as faces (or parts thereof), animals, common objects (e.g., cars, tools), etc. The model output shall tag recognized objects with their respective positions in the video frame (e.g., bounding box coordinates) and the corresponding timestamp (e.g., relative to beginning of video file). As an object position changes in different video frames, a series of data records should be output by the model with different positions and time stamps.

An example performance metric for this bootstrapper model output is weighted average of the following:
portion of objects that are unrecognized and/or misclassified, and
cumulative difference between object locations in the model output and actual object locations at the same time stamps.

The received video files may exhibit the following degradations that are reflected in QoE labels:
delays/stalls, such that timestamp labels differ between original and received video file;
missing chunks of the incoming video, with failure to recognize objects that appear at timestamps within these chunks; and
reduced resolution, resulting in misclassification or failure to recognize objects.
imprecise position labels.

For conversational video with screen sharing, optical character recognition (OCR) models can be used instead of or in addition to the object detector models mentioned above. OCR models are able to recognize text on images. In case the shared screen contains text, the OCR model shall recognize it and transcribe it to a proper character sequence. Timestamp and position labels are required in this case, too. An example performance metric for this bootstrapper model output is weighted average of the following:
edit distance between actual text and the OCR model output,
cumulative difference of time stamps designating text change (e.g., when changing slides in a presentation).

QoE degradations and their effects on the OCR performance are similar to the degradations listed above for the streaming and conversational video services example.

Note that since most video services also include a voice track, multiple bootstrapper models should be applied to fully measure QoE: one model for voice and one model for video. The QoE degradation of misaligned voice and video tracks will affect timestamps of the voice recognition model output, the object detection/OCR model output, or both.

Note that since conversational voice and video services are usually bi-directional, two test devices and two video files (with audio tracks) can be used in a test session, one transmitted by the UE and the other transmitted by the network. Bootstrapper model(s) can be applied to each received file.

Although the present disclosure provides various example use cases or media types, it should be understood that the disclosed techniques can also be applied to other use cases or media types, provided that the following are available:
appropriate bootstrapper model(s);
appropriate technique for characterizing the bootstrapper model output;
appropriate technique for characterizing QoE degradation between performance of bootstrapper model for original and received media file; and
association between QoE degradation and corresponding network QoS metrics or KPIs.

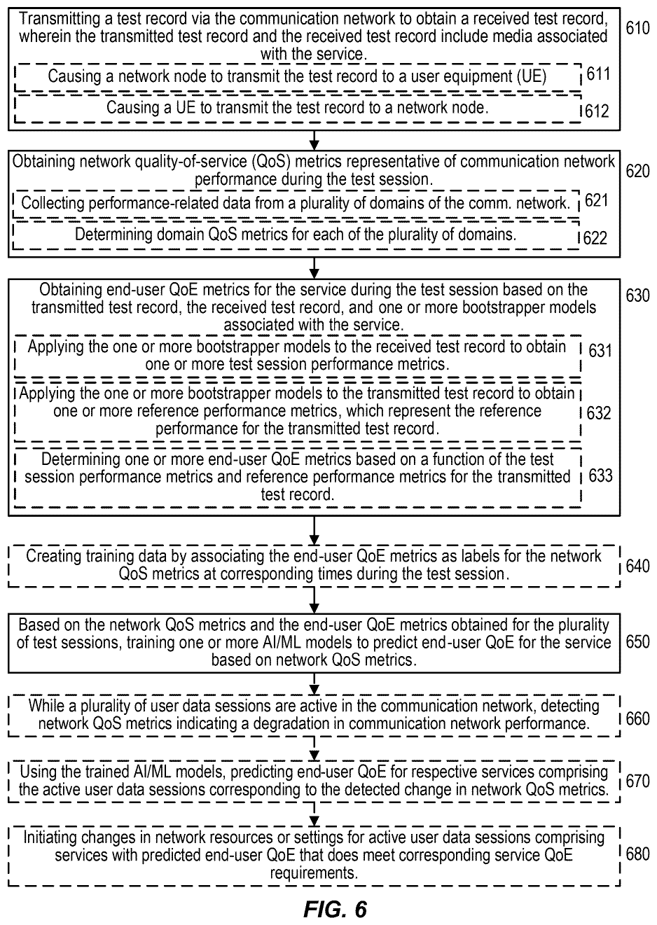

Various features of the embodiments described above correspond to various operations illustrated in FIG. 6 (including parts A and B), which shows an exemplary method (e.g., procedure) for training AI/ML models to predict end-user QoE in a communication network, according to various embodiments of the present disclosure. In other words, various features of the operations described below correspond to various embodiments described above. Although FIG. 6 shows specific blocks in a particular order, the operations of the exemplary method can be performed in a different order than shown and can be combined and/or divided into blocks having different functionality than shown. Optional blocks or operations are indicated by dashed lines.

The following description is based on the exemplary method being performed by a network analytics system associated the communication network. For example, the network analytics system can be implemented in (or as) a service management and orchestration (SMO) system for a RAN, an analytics-related CN node such as NWDAF, a network management node in an OAM system, or an application running in a host computing system external to the network (e.g., public or private cloud environment).

The network analytics system can perform the operations of blocks 610-630 for each of a plurality of test sessions for a service. In block 610, the network analytics system can transmit a test record via the communication network to obtain a received test record. The transmitted test record and the received test record include media associated with the service. In block 620, the network analytics system can obtain network QoS metrics representative of communication network performance during the test session. In block 630, the network analytics system can obtain end-user QoE metrics for the service during the test session based on the transmitted test record, the received test record, and one or more bootstrapper models associated with the service.

The exemplary method can also include the operations of block 650, where based on the network QoS metrics and the end-user QoE metrics obtained for the plurality of test sessions, the network analytics system can train one or more AI/ML models to predict end-user QoE for the service based on network QoS metrics.

In some embodiments, the exemplary method can also include the operations of block 640, where for each test session, the network analytics system can create training data by associating the end-user QoE metrics as labels for the network QoS metrics at corresponding times during the test session. In such embodiments, training the one or more AI/ML models (e.g., in block 650) is based on the training data created for the plurality of test sessions.

In some embodiments, obtaining network QoS metrics representative of communication network performance during the test session in block 620 can include the operations of sub-blocks 621-622, where the network analytics system can collect performance-related data from a plurality of domains of the communication network and determine domain QoS metrics for each of the plurality of domains. In some of these embodiments, the plurality of domains include at least two of the following: a UE domain, a RAN domain, a core network (CN) domain, and an IMS domain. In some of these embodiments, one or more of the following applies:
the RAN-domain QoS metrics for each test session include one or more of the following: RAN resources used, serving cell load, mobility events between serving cells, and serving and neighbor cell radio measurements.
the CN-domain QoS metrics for each test session include one or more of the following: packet delay, packet delay jitter, packet loss, and priority level

In some of these embodiments, the performance-related data (e.g., collected in sub-block 621) includes one or more of the following:
trace data for respective cells provided by RAN nodes;
performance management (PM) counter data associated with the RAN nodes;
user plane (UP) event information associated with the CN; and
control plane (CP) event information associated with the CN.

In some embodiments, obtaining end-user QoE metrics for the service during the test session in block 630 includes the operations of sub-blocks 631 and 633, where the network analytics system can apply the one or more bootstrapper models to the received test record to obtain one or more test session performance metrics, and determine one or more end-user QoE metrics based on a function of the test session performance metrics and performance metric for the transmitted test record.

In some of these embodiments, obtaining end-user QoE metrics for the service during the test session in block 630 also includes the operations of sub-block 632, where the network analytics system can apply the one or more bootstrapper models to the transmitted test record to obtain one or more reference performance metrics, which represent the reference performance for the transmitted test record. In other of these embodiments, the reference performance is based on known or predetermined performance of the one or more bootstrapper models with respect to the transmitted test record.

In some of these embodiments, the one or more test session performance metrics include one or more of the following: accuracy, precision, recall, F1-score, area under curve, word error rate, and character error rate.

In other of these embodiments, the service is voice, the one or more bootstrapper models include a speech-to-text model, and the test session performance metrics for the speech-to-text model include a weighted average of the following: edit distance between actual text for the test record and corresponding output text of the speech-to-text model, and cumulative differences between time stamps of the actual text and the corresponding output text of the speech-to-text model.

In other of these embodiments, the service is video, the one or more bootstrapper models include an object detection model, and the test session performance metrics for the object detection model include a weighted average of the following: portion of identifiable objects in the test record that were unrecognized and/or misclassified by the object detection model, and cumulative difference between actual object locations in the test record and object locations identified by the object detection mode, at corresponding times. In some variants, the one or more bootstrapper models (i.e., for video service) also include a speech-to-text model.

In other of these embodiments, the service is conversational screen sharing, the one or more bootstrapper models include an optical character recognition (OCR) model, and the test session performance metrics for the OCR model include a weighted average of the following: edit distance between actual text for the test record and corresponding output text of the OCR model, and cumulative differences between time stamps of the actual text and the corresponding output text of the OCR model. In some variants, the one or more bootstrapper models (i.e., for conversational screen sharing service) also include a speech-to-text model and/or an object detection model.

In some embodiments, the end-user QoE metrics for the service during each test session (e.g., determined in block 630) include one or more of the following:
a qualitative rating having one of at least two possible values (e.g., “good”, “bad”); and
a numerical rating within a range that includes a minimum value (e.g., 0 or 1) and a maximum value (e.g., 5 or 10), wherein the maximum value corresponds to a reference performance metric for the service.

In some embodiments, each test session comprises a plurality of time segments, with network QoS metrics and end-user QoE metrics being obtained for each of the plurality of time segments. In some embodiments, the method (i.e., at least blocks 610-630, 650) is repeated for a plurality of different services, resulting in trained service-specific AI/ML models capable of predicting end-user QoE for the respective service based on network QoS metrics.

In some embodiments, transmitting a test record via the communication network in block 610 can include one of the following operations labelled with corresponding sub-block numbers:
(611) causing a network node to transmit the test record to a UE; or
(612) causing a UE to transmit the test record to a network node.

In some of these embodiments, the service is a bidirectional service and the plurality of test sessions include a first plurality of test sessions in which the network node is caused to transmit a test record to a UE, and a corresponding first plurality of test sessions in which the UE is caused to transmit a test record to the network node.

In some embodiments, the exemplary method can include the following operations performed by the network analytics system, labelled with corresponding block numbers:
(660) while a plurality of user data sessions are active in the communication network, detecting network QoS metrics indicating a degradation in communication network performance;
(670) using the trained AI/ML models, predicting end-user QoE for respective services comprising the active user data sessions corresponding to the detected change in network QoS metrics; and
(680) initiating changes in network resources or settings for active user data sessions comprising services with predicted end-user QoE that does meet corresponding service QoE requirements.

An example of these operations are the “improvement actions” shown in FIG. 4.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

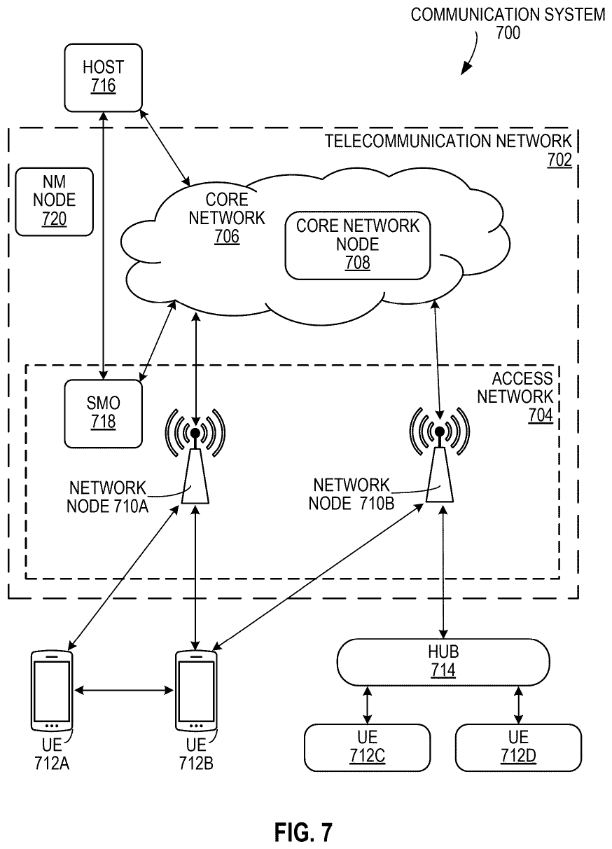

FIG. 7 shows an example of a communication system 700 in accordance with some embodiments. In this example, the communication system 700 includes a telecommunication network 802 that includes an access network 704, such as a RAN, and a core network 706, which includes one or more core network nodes 708. In some embodiments, telecommunication network 702 can also include one or more Network Management (NM) nodes 718, which can be part of an operation support system (OSS), a business support system (BSS), and/or an OAM system. The NM nodes can monitor and/or control operations of other nodes in access network 704 and core network 706. Although not shown in FIG. 7, NM node 718 is configured to communicate with other nodes in access network 704 and core network 706 for these purposes.

Access network 704 includes one or more access network nodes, such as network nodes 710a and 710b (one or more of which may be generally referred to as network nodes 710), or any other similar 3GPP access node or non-3GPP access point. The network nodes 710 facilitate direct or indirect connection of UEs, such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In some embodiments, access network 704 can include a service management and orchestration (SMO) system or node 720, which can monitor and/or control operations of the access network nodes 710. This arrangement can be used, for example, when access network 704 utilizes an Open RAN (O-RAN) architecture. SMO system 720 can be configured to communicate with core network 706 and/or host 716, as shown in FIG. 7.

In some embodiments, one or more of host 716, network management node 718, and SMO system 720 can be configured to perform various operations of exemplary methods (e.g., procedures) for training AI/ML models to predict end-user QoE in a communication network, such as described above in relation to FIG. 6.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

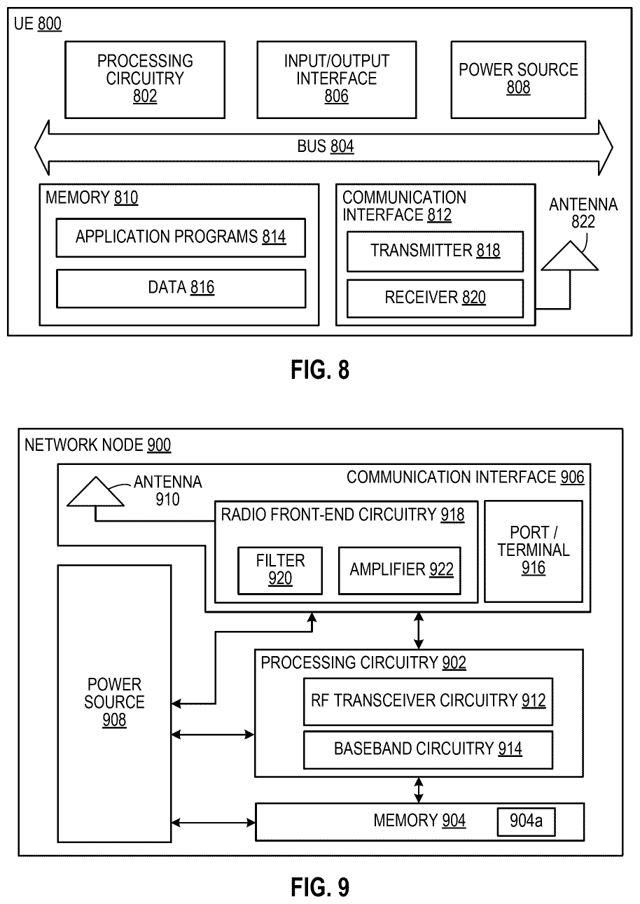

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In some embodiments, network node 900 can be configured to perform various operations of exemplary methods (e.g., procedures) for training AI/ML models to predict end-user QoE in a communication network, such as described above in relation to FIG. 6.

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions (collectively denoted computer program product 904a) capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

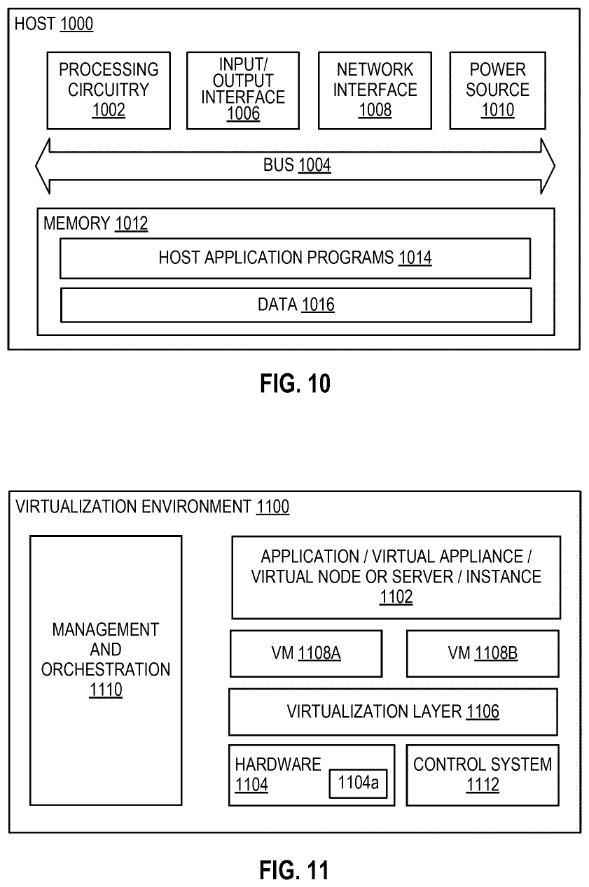

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In some embodiments, host 1000 can be configured to perform various operations of exemplary methods (e.g., procedures) for training AI/ML models to predict end-user QoE in a communication network, such as described above in relation to FIG. 6.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein. In some embodiments, one or more applications 1102 can be configured to perform various operations of exemplary methods (e.g., procedures) for training AI/ML models to predict end-user QoE in a communication network, such as described above in relation to FIG. 6.

Hardware 1104 includes processing circuitry, memory that stores software and/or instructions (collectively denoted computer program product 1104a) executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

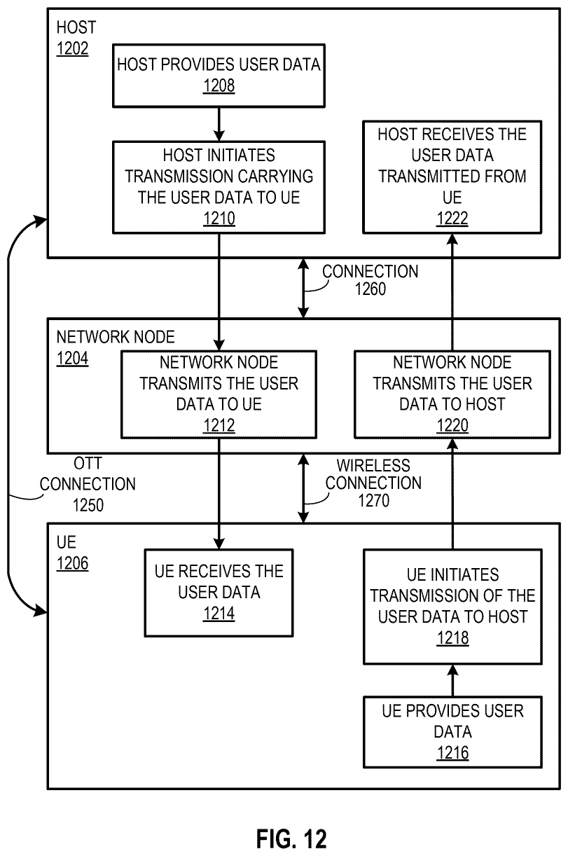

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, embodiments can utilize bootstrapper models that are readily available for many services such as speech-to-text models for various languages, object detection models for video streams, picture-to-text models, etc. Embodiments can reduce cost and complexity of generating training data as compared to conventional techniques, and can improve accuracy and/or precision of the QoE AI/ML models resulting from the training data.

Embodiments are applicable to a wide range of services and/or use cases that are expected in 5G networks, including services that encrypt traffic sent over the 5G network. By improving the training of AI/ML models used to predict end-user QoE, embodiments facilitate better prediction of end-user QoE in networks, thereby improving network compliance with QoE requirements in OTT service provider SLAs. This directly benefits OTT service providers and end users.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc. but need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1. A computer-implemented method for training artificial intelligence/machine learning, AI/ML, models to predict end-user quality-of-experience, QoE, in a communication network, the method comprising:
performing the following for each of a plurality of test sessions for a service:
transmitting a test record via the communication network to obtain a received test record, wherein the transmitted test record and the received test record include media associated with the service;
obtaining network quality-of-service, QoS, metrics representative of communication network performance during the test session;
obtaining end-user QoE metrics for the service during the test session based on the transmitted test record, the received test record, and one or more bootstrapper models associated with the service; and
based on the network QoS metrics and the end-user QoE metrics obtained for the plurality of test sessions, training one or more AI/ML models to predict end-user QoE for the service based on network QoS metrics.

2. The method of claim 1, further comprising, for each test session, creating training data by associating the end-user QoE metrics as labels for the network QoS metrics at corresponding times during the test session, wherein training the one or more AI/ML models is based on the training data created for the plurality of test sessions.

3. The method of claim 1, wherein obtaining network QoS metrics representative of communication network performance during the test session comprises:
collecting performance-related data from a plurality of domains of the communication network; and
determining domain QoS metrics for each of the plurality of domains.

4. The method of claim 3, wherein the plurality of domains include at least two of the following: a user equipment, UE, domain; a radio access network, RAN, domain; a core network, CN, domain; and an IP multimedia system, IMS, domain.

5. The method of claim 4, wherein:
the RAN-domain QoS metrics for each test session include one or more of the following: RAN resources used, serving cell load, mobility events between serving cells, and serving and neighbor cell radio measurements; and
the CN-domain QoS metrics for each test session include one or more of the following: packet delay, packet delay jitter, packet loss, and priority level.

6. The method of claim 4, wherein the performance-related data includes one or more of the following:
trace data for respective cells provided by RAN nodes;
performance management, PM, counter data associated with the RAN nodes;
user plane, UP, event information associated with the CN; and
control plane, CP, event information associated with the CN.

7. The method of claim 1, wherein obtaining end-user QoE metrics for the service during the test session comprises:
applying the one or more bootstrapper models to the received test record to obtain one or more test session performance metrics; and
determining one or more end-user QoE metrics based on a function of the test session performance metrics and reference performance for the transmitted test record.

8. The method of claim 7, wherein obtaining end-user QoE metrics for the service during the test session further comprises applying the one or more bootstrapper models to the transmitted test record to obtain one or more reference performance metrics, which represent the reference performance for the transmitted test record.

9. The method of claim 7, wherein the reference performance is based on known or predetermined performance of the one or more bootstrapper models with respect to the transmitted test record.

10. The method of claim 7, wherein the one or more test session performance metrics include one or more of the following: accuracy, precision, recall, F1-score, area under curve, word error rate, and character error rate.

11. The method of claim 7, wherein:
the service is voice and the one or more bootstrapper models include a speech-to-text model; and
the test session performance metrics for the speech-to-text model include a weighted average of the following:
edit distance between actual text for the test record and corresponding output text of the speech-to-text model, and
cumulative differences between time stamps of the actual text and the corresponding output text of the speech-to-text model.

12. The method of claim 7, wherein:
the service is video and the one or more bootstrapper models include an object detection model; and
the test session performance metrics for the object detection model include a weighted average of the following:
portion of identifiable objects in the test record that were unrecognized and/or misclassified by the object detection model, and
cumulative difference between actual object locations in the test record and object locations identified by the object detection mode, at corresponding times.

13. The method of claim 12, wherein the one or more bootstrapper models also include a speech-to-text model.

14. The method of claim 7, wherein:
the service is conversational screen sharing and the one or more bootstrapper models include an optical character recognition, OCR, model; and
the test session performance metrics for the OCR model include a weighted average of the following:
edit distance between actual text for the test record and corresponding output text of the OCR model, and
cumulative differences between time stamps of the actual text and the corresponding output text of the OCR model.

15. (canceled)

16. The method of claim 1, wherein the end-user QoE metrics for the service during each test session include one or more of the following:
a qualitative rating having one of at least two possible values; and
a numerical rating within a range that includes a minimum value and a maximum value, wherein the maximum value corresponds to a reference performance metric for the service.

17. The method of claim 1, wherein each test session comprises a plurality of time segments, with network QoS metrics and end-user QoE metrics being obtained for each of the plurality of time segments.

18. The method of claim 1, wherein transmitting a test record via the communication network comprises one of the following:
causing a network node to transmit the test record to a user equipment, UE; or
causing a UE to transmit the test record to a network node.

19. (canceled)

20. The method of claim 1, wherein the method is repeated for a plurality of different services, resulting in trained service-specific AI/ML models capable of predicting end-user QoE for the respective service based on network QoS metrics.

21-23. (canceled)

24. A network analytics system configured to train artificial intelligence/machine learning, AI/ML, models to predict end-user quality-of-experience (QoE) in a communication network, the network analytics system being further configured to:
perform the following for each of a plurality of test sessions for a service:
transmit a test record via the communication network to obtain a received test record, wherein the transmitted test record and the received test record include media associated with the service;
obtain network quality-of-service, QoS, metrics representative of communication network performance during the test session;
obtain end-user QoE metrics for the service during the test session based on the transmitted test record, the received test record, and one or more bootstrapper models associated with the service; and
based on the network QoS metrics and the end-user QoE metrics obtained for the plurality of test sessions, train one or more AI/ML models to predict end-user QoE for the service based on network QoS metrics.

25. (canceled)

26. A non-transitory, computer-readable medium storing computer-executable instructions that, when executed by processing circuitry associated with a network analytics system configured to train artificial intelligence/machine learning, AI/ML, models to predict end-user quality-of-experience, QoE, in a communication network, configure the network analytics system to perform the method of claim 1.

27. (canceled)
